(19) United States
(12) Patent Application Publication
(10) Pub. No.: US 2026/0037956 A1
(43) Pub. Date: Feb. 5, 2026

(54) SIGNED BLOCKCHAIN TRANSACTIONS USING NON-INTERNET PROTOCOL TRANSMISSIONS

(71) Applicant: Mysten Labs, Inc., Palo Alto, CA (US)

(72) Inventors: Kostas Chalkias, Dubai (AE); Nikolaos Kitmeridis, Thessaloniki (GR); John Naulty, Fort Bragg, CA (US); Ryan Servatius, Seattle, WA (US); Adeniyi Abiodun, San Jose, CA (US); Christian Thompson, Grand Cayman (KY)

(73) Assignee: Mysten Labs, Inc., Palo Alto, CA (US)

(21) Appl. No.: 19/043,794

(22) Filed: Feb. 3, 2025

Related U.S. Application Data
(60) Provisional application No. 63/560,952, filed on Mar. 4, 2024.

(30) Foreign Application Priority Data
Feb. 22, 2024 (GR) 20240100132

(51) Int. Cl. G06Q 20/36; G06Q 20/32; G06Q 20/38; H04L 67/56

(52) U.S. Cl. CPC G06Q 20/36; G06Q 20/3255; G06Q 20/389; H04L 67/56; G06Q 2220/00

(57) ABSTRACT

The present technology pertains to a hybrid communication blockchain transaction communication system and method of using the same. A method is disclosed for facilitating internet-less blockchain transactions. The method involves an application sending an SMS message requesting a coin object with a minimum value, identifying the sender's wallet address, and storing the coin object on a blockchain. The application then receives an SMS with the coin object identification, versioned ID, and digest. The application captures user input to define the recipient wallet address and transaction type. It sends a third SMS containing the sender's signature and transaction details, including the sender's wallet address, coin object ID as gas input, recipient wallet address, and transaction type. The application receives a fourth SMS with a transaction digest, confirming the transaction has been recorded on the blockchain.

### CROSS REFERENCE TO RELATED APPLICATIONS

This application claims priority to U.S. provisional application No. 63/560,952, filed on Mar. 4, 2024, and Greek patent application 20240100132 filed Feb. 22, 2024 entitled “SIGNED BLOCKCHAIN TRANSACTIONS USING NON-INTERNET PROTOCOL TRANSMISSIONS,” the contents of which are incorporated by reference herein in its entirety and which is a basis for a claim of priority.

### FIELD OF THE TECHNOLOGY

The present disclosure generally relates to a hybrid communication blockchain transaction communication system for conducting a signed blockchain transaction by a non- internet protocol (IP) message.

### BACKGROUND

Blockchain technology offers a transformative approach to performing commercial transactions by leveraging its core attributes of decentralization, transparency, and security. Blockchain provides a distributed ledger system where transactions are recorded across a network of computers, ensuring that no single entity controls the entire system. This decentralization eliminates the need for intermediaries, such as banks or payment processors, thereby reducing transaction costs and enhancing efficiency. Each transaction is cryptographically secured and linked to the previous transaction, forming a chain of blocks that ensures data integrity and immutability. Once recorded, transactions cannot be easily altered or deleted, providing a permanent and tamper-proof record.

When conducting commercial transactions, blockchain technology enables businesses to execute transactions with high security and transparency. Each transaction is verified by a network of nodes through a consensus mechanism, ensuring that all participants agree on the validity of the transaction before it is recorded in the blockchain. This consensus method prevents fraud and minimizes the risk of double-spending, which is crucial for maintaining the integrity of financial transactions. Furthermore, blockchain technology provides transparency by allowing all participants in the network to view and verify transactions. This visibility fosters trust among parties by providing an immutable record of transactions that can be audited at any time. For businesses, this means that transaction histories are easily traceable, which can be particularly valuable for compliance and auditing purposes.

Furthermore, blockchain technology enhances financial inclusion by providing access to secure financial services for unbanked and underbanked populations. Blockchain-based solutions offer a viable alternative for conducting commercial transactions in regions with limited access to traditional banking infrastructure. Individuals and businesses can participate in the global economy, receiving and making payments through blockchain networks without a conventional bank account.

### BRIEF DESCRIPTION OF THE SEVERAL VIEWS OF THE DRAWINGS

In order to describe the manner in which the features of the disclosure can be obtained, a more description of the principles of the present technology will be rendered by reference to aspects thereof which are illustrated in the appended drawings. Understanding that these drawings depict exemplary aspects of the disclosure and are not therefore to be considered to be limiting of its scope, the principles herein are described and explained with additional specificity and detail through the use of the accompanying drawings in which:

FIG. 1 illustrates an example hybrid communication blockchain transaction communication system in accordance with some aspects of the present technology.

FIG. 2 illustrates an example routine for transacting with a blockchain using non-internet protocol messages such as an SMS message, in accordance with some aspects of the present technology.

FIG. 3 illustrates the contents of SMS messages exchanged in accordance with some aspects of the present technology.

FIG. 4 illustrates an example interface of the mobile application used to configure a request for a token with a non-zero value in accordance with some aspects of the present technology.

FIG. 5 illustrates an example user interface of the mobile application after submitting an SMS to a recipient, where the user interface identifies the token with the non-zero value in accordance with some aspects of the present technology.

FIG. 6 illustrates an example user interface of the mobile application as it receives the fourth SMS message including a transaction digest showing that the transaction on the blockchain was completed in accordance with some aspects of the present technology.

FIG. 7 illustrates a blockchain transaction process in accordance with some aspects of the present technology.

FIG. 8 illustrates a blockchain formation for implementing certain aspects of the present technology in accordance with some aspects of the present technology.

FIG. 9 illustrates an irreversible transaction in blockchain implementing certain aspects of the present technology.

FIG. 10 shows an example of a system for implementing certain aspects of the present technology.

### DETAILED DESCRIPTION

Various examples of the disclosure are discussed in detail below. While specific implementations are discussed, it should be understood that this is done for illustration purposes. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an example in the present disclosure can be references to the same example or any example; and, such references mean at least one of the examples.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative, and is not intended to further limit the scope and meaning of the disclosure or of any example term. Likewise, the disclosure is not limited to various embodiments given in this specification.

Additional features and advantages of the disclosure will be set forth in the description that follows and, in part, will be obvious from the description or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Blockchain technology typically relies on internet connectivity for node communication, transaction broadcasting, and consensus mechanisms. However, many regions around the world still suffer from unreliable or nonexistent data network coverage, posing a significant barrier to the adoption of blockchain solutions. To address this issue, it is imperative to develop methods that enable users to interact with blockchain networks through alternative communication channels. This can include short message services (SMS), FM/AM radio signals, satellite transmissions, and other non-internet-based transmission types.

Implementing such solutions involves leveraging the ubiquity and reliability of these alternative networks to facilitate blockchain transactions. For instance, SMS can serve as a medium for sending and receiving transaction data, allowing users to initiate and confirm blockchain transactions without the need for internet access. FM/AM radio signals can be used to broadcast blockchain updates and transaction information, reaching even the most remote areas. Satellite communications offer another robust option, providing a global reach that can ensure connectivity in areas where traditional networks fail.

While technologies exist that connect SMS networks to the Internet, implementation of the present technology is more challenging than simply sending an SMS message to a receiver for forwarding to a blockchain network. For example, blockchain transactions often require long messages, whereas SMS messages are limited to 160 characters. Therefore, at a minimum, the present technology needs to send serial SMS messages and stitch them back together to recreate the messages. Alternatively, the present technology contemplates a condensed messaging scheme to reduce the size of the SMS messages. Another challenge is that blockchain transactions need to be signed. Data networks utilize a variety of secure messaging protocols when sending data along with a cryptographic signature, but SMS message services do not have such infrastructure. Another challenge is that the endpoint communicating with the blockchain network must have knowledge of the blockchain SDK. Therefore, an SMS message receiver cannot forward data from an SMS message to a blockchain network without further modifications.

The present technology addresses these challenges by aiming to facilitate the execution of internet-less transactions by providing users with mobile applications capable of preparing and signing transaction blocks offline. These mobile applications can empower users to create secure transactions even without internet access, leveraging alternative communication channels such as Bluetooth, mesh networks, or satellite links to order the execution of these transactions. Once the transaction blocks are signed, they can be transmitted through these non-internet channels to relay points or intermediary devices. These devices, which have intermittent or direct internet connectivity, will then forward the transaction execution orders to full nodes through traditional internet-based entry points. This approach ensures that the integrity and security of the blockchain are maintained while enabling users in remote or connectivity-limited areas to participate seamlessly in blockchain transactions.

In some aspects, the techniques described herein relate to a method including: sending, by an application, a first short message service (SMS) message, the first SMS message requesting a coin object having at least a minimum value and identifying a wallet address of a sender, the coin object being stored on a blockchain; receiving, by the application, a second SMS message, the second SMS message including an identification of the coin object having the at least the minimum value, a versioned ID of object, and a digest; receiving, by the application, data input into a user interface of the application that is effective to define at least a recipient wallet address and a type of transaction to occur on the blockchain; sending, by the application, a third SMS message, the third SMS message including a signature for the sender, and transaction details including at least the wallet address of the sender, an identification of the coin object as a gas input, the recipient wallet address, and the type of transaction; and receiving, by the application, a fourth SMS message, the fourth SMS message including a transaction digest with proof that the transaction has been recorded on the blockchain.

In some aspects, the techniques described herein relate to a method, wherein content within the SMS messages are exchanged between a blockchain proxy and the application, wherein the blockchain proxy is configured to translate a context with the SMS messages into messages compatible with a blockchain software developer kit.

In some aspects, the techniques described herein relate to a method, wherein the SMS messages are exchanged with an SMS forwarding service, wherein the SMS forwarding service is configured to be an interface between an SMS network and an IP network, wherein the SMS forwarding service communicates with the application over the SMS network and communicates with the blockchain proxy over an IP network, wherein the SMS forwarding service forwards messages received from the application to the blockchain proxy and forwards messages received from the blockchain proxy to the application.

In some aspects, the techniques described herein relate to a method, wherein the SMS forwarding service is co-located with a blockchain node.

In some aspects, the techniques described herein relate to a method, wherein the SMS forwarding service is co-located with the blockchain proxy.

In some aspects, the techniques described herein relate to a method, wherein any of the first SMS message, the second SMS message, the third SMS message, or the fourth SMS message are divided over a plurality of SMS transmissions in order to keep the SMS transmissions under a maximum character length.

In some aspects, the techniques described herein relate to a method, wherein any of the first SMS message, the second SMS message, the third SMS message, or the fourth SMS message are encoded to a number of characters less than a maximum character length for an SMS transmission, wherein the application and a blockchain proxy are endowed with instructions to decode the SMS transmission.

In some aspects, the techniques described herein relate to a method, wherein the application can select from one of several blockchain networks on which to conduct the transaction, and the first SMS message and the second SMS message identify the one of the several blockchain networks.

In some aspects, the techniques described herein relate to a method, wherein the SMS message could be substituted for FM/AM radio signals, or satellite transmissions.

In some aspects, the techniques described herein relate to a system including: one or more processors; and memory storing thereon instructions that, as a result of being executed by the one or more processors, cause the system to: send, by an application, a first short message service (SMS) message, the first SMS message requesting a coin object having at least a minimum value and identifying a wallet address of a sender, the coin object being stored on a blockchain; receive, by the application, a second SMS message, the second SMS message including an identification of the coin object having the at least the minimum value, a versioned ID of object, and a digest; receive, by the application, data input into a user interface of the application that is effective to define at least a recipient wallet address and a type of transaction to occur on the blockchain; send, by the application, a third SMS message, the third SMS message including a signature for the sender, and transaction details including at least the wallet address of the sender, an identification of the coin object as a gas input, the recipient wallet address, and the type of transaction; and receive, by the application, a fourth SMS message, the fourth SMS message including a transaction digest with proof that the transaction has been recorded on the blockchain.

In some aspects, the techniques described herein relate to a non-transitory computer-readable storage medium, the computer-readable storage medium including instructions that when executed by a computer, cause the computer to: send, by an application, a first short message service (SMS) message, the first SMS message requesting a coin object having at least a minimum value and identifying a wallet address of a sender, the coin object being stored on a blockchain; receive, by the application, a second SMS message, the second SMS message including an identification of the coin object having the at least the minimum value, a versioned ID of object, and a digest; receive, by the application, data input into a user interface of the application that is effective to define at least a recipient wallet address and a type of transaction to occur on the blockchain; send, by the application, a third SMS message, the third SMS message including a signature for the sender, and transaction details including at least the wallet address of the sender, an identification of the coin object as a gas input, the recipient wallet address, and the type of transaction; and receive, by the application, a fourth SMS message, the fourth SMS message including a transaction digest with proof that the transaction has been recorded on the blockchain.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

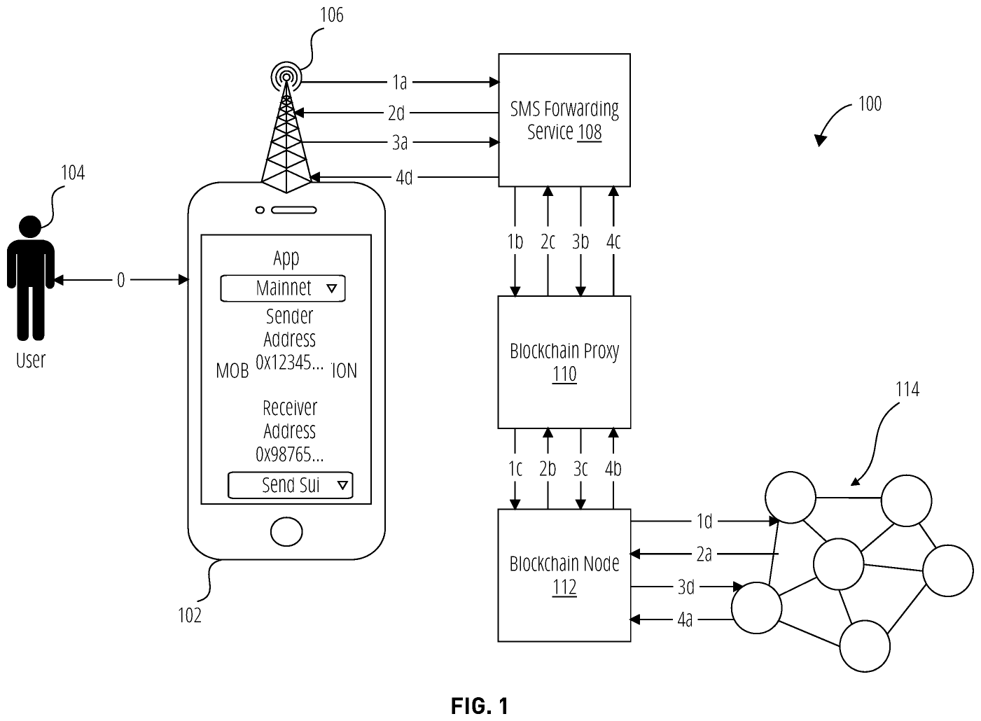

FIG. 1 illustrates an example hybrid communication blockchain transaction communication system 100 in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components, some components might not be present or needed, and additional components may be present.

Hybrid communication blockchain transaction communication system 100 includes a user 104 interacting with a mobile application 102 on a client device, where the client device may not have access to an internet protocol (IP) network to provide data transmissions. Accordingly, the mobile application 102 can cause SMS messages to be exchanged with an SMS forwarding service 108.

The SMS forwarding service 108 is configured to be an interface between an SMS network and an IP network. The SMS forwarding service 108 is configured to facilitate seamless communication and data transfer between mobile applications and blockchain networks, even in environments with limited internet connectivity.

The SMS forwarding service 108 can receive messages from the mobile application 102 over the SMS network, ensuring that users can interact with blockchain services using standard text messaging. SMS forwarding service 108 then translates and forwards these messages to blockchain proxy 110 over an IP network.

SMS forwarding service 108 also handles responses from blockchain proxy 110. SMS forwarding service 108 can receive messages from blockchain proxy 110 via the IP network, translate the received messages into SMS format, and send them back to mobile application 102 on the SMS network. The bidirectional communication between SMS forwarding service 108 and blockchain proxy 110 allows users users to receive blockchain transaction confirmations and other relevant information through SMS, without relying on continuous internet access.

Blockchain proxy 110 functions as an intermediary service that facilitates communication between mobile application 102 and blockchain network 114. By utilizing a blockchain SDK, blockchain proxy 110 can receive messages from mobile application 102 and subsequently interact with blockchain network 114 to execute transactions, query data, or perform other blockchain-related operations.

Blockchain node 112 is a node within blockchain network 114. Blockchain node 112, as a node can participate in the consensus method, maintains the distributed ledger, and validates transactions.

While the described components can be shown separately, some of these components can be co-located to provide a more efficient system. For example, SMS forwarding service 108 can be co-located with blockchain node 112 or with blockchain proxy 110.

While FIG. 1 illustrates a system wherein SMS messages are used as an example of a non-internet protocol transmission, other types of transmissions can be substituted, including but not limited to FM/AM radio signals, satellite transmissions, Bluetooth, mesh networks, and other wireless communication methods. The following discussion of FIG. 1 describes communications between each of the described components making up the hybrid communication blockchain transaction communication system 100.

At step 0, user 104 uses mobile application 102 to interact with blockchain network 114, but the mobile device does not have direct internet access or otherwise cannot perform IP transactions.

In Communication 1a, the mobile application 102 sends a first SMS message to request the Coin objects that belong to the sender address, with the SMS text containing the address and the targeted network (mainnet, testnet, etc.). This SMS is then forwarded to the registered virtual mobile number of the SMS forwarding service. The method may also include dividing the first SMS message over a plurality of SMS transmissions to keep each transmission under a maximum character length.

In Communication 1b, the SMS content is forwarded by the SMS forwarding service to the blockchain proxy via HTTP.

In Communication 1c, the blockchain proxy integrates with the blockchain SDK and requests the blockchain node 112 to execute the ‘getOwnedObjectsJsonRPC’ call.

In Communication 1d, the blockchain node 112 executes the ‘getOwnedObjectsJsonRPC’ call.

In Communication 2a, the blockchain node 112 receives the requested data (the coin objects) from the blockchain network 114.

In Communication 2b, the blockchain node 112 sends a response to the blockchain proxy 110, which filters the received coin objects and returns the first coin object with a non-zero balance.

In Communication 2c, the blockchain proxy 110 encodes the coin object in Base64 using the blockchain SDK and sends it to the SMS forwarding service 108 via HTTP.

In Communication 2d, the SMS forwarding service 108 creates and transmits the second SMS message containing an identification of the coin object on the targeted network (mainnet, testnet, etc.) from the registered number. The method may also include dividing the second SMS message over a plurality of SMS transmissions to keep each transmission under a maximum character length.

In Communication 3a, the mobile application 102 listens to the incoming second SMS message and converts it back to the coin object using the blockchain SDK. The mobile application 102 prepares the blockchain transaction data, including the received coin object info and the user signature, using the blockchain SDK. The mobile application 102 then converts them to Base64 format and submits them via the third SMS message, which is sent to the registered virtual mobile number of the SMS forwarding service 108. The method may also include dividing the third SMS message over a plurality of SMS transmissions to keep each transmission under a maximum character length.

In Communication 3b, the SMS content is forwarded by the SMS forwarding service 108 to the blockchain proxy 110 via HTTP.

In Communication 3c, the blockchain proxy 110 uses the blockchain SDK to request the blockchain node 112 to execute the transaction using the ‘executeTransactionBlockJsonPPC’ call.

In Communication 3d, the blockchain node 112 conducts the transaction with the blockchain network 114.

In Communication 4a, after the transaction block has been executed on blockchain network 114, the outcome is returned to the blockchain proxy 110.

In Communication 4b, the blockchain proxy 110 extracts the transaction digest using the blockchain SDK and sends the transaction digest to the SMS forwarding service via HTTP.

In Communication 4c, the SMS forwarding service forwards the transaction digest via a fourth SMS message.

In Communication 4d, the mobile application 102 listens to the incoming fourth SMS message and renders the transaction digest for confirmation of successful execution.

The method may also include dividing any of the first SMS message, the second SMS message, the third SMS message, or the fourth SMS message over a plurality of SMS transmissions to keep each transmission under a maximum character length.

The method may also include encoding any of the first SMS message, the second SMS message, the third SMS message, or the fourth SMS message to a number of characters less than the maximum character length for an SMS transmission, with the application and the blockchain proxy equipped with instructions to decode the SMS transmission.

The method may also include the application selecting from one of several blockchain networks on which to conduct the transaction, with the first SMS message and the second SMS message identifying the chosen blockchain network.

Other technical features may be readily apparent to one skilled in the art from the following figures, descriptions, and claims.

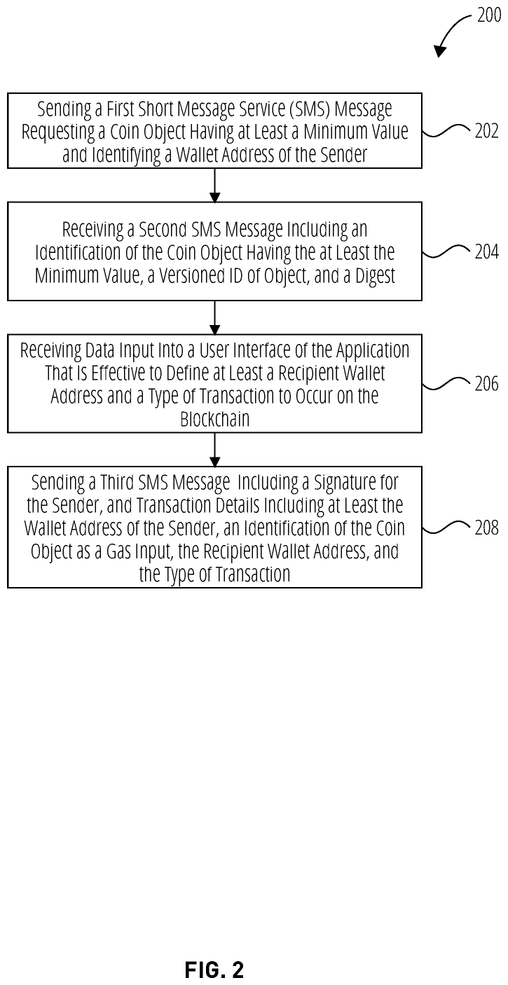

FIG. 2 illustrates an example method 200 for transacting with a blockchain using non-internet protocol messages such as an SMS message, in accordance with some aspects of the present technology. Although the example method 200 depicts a particular sequence of operations, the sequence may be altered without departing from the scope of the present disclosure. For example, some of the operations depicted may be performed in parallel or in a different sequence that does not materially affect the function of the method 200. In other examples, different components of an example device or system that implements the method 200 may perform functions at substantially the same time or in a specific sequence.

According to some examples, the method includes sending a first short message service (SMS) message requesting a coin object having at least a minimum value and identifying a wallet address of the sender at block 202. For example, the mobile application 102 illustrated in FIG. 1 may send a first short message service (SMS) message requesting a coin object having at least a minimum value and identifying a wallet address of the sender. The coin object being stored on a blockchain.

According to some examples, the method includes receiving a second SMS message including an identification of the coin object having the at least the minimum value, a versioned ID of object, and a digest at block 204. For example, the mobile application 102 illustrated in FIG. 1 may receive a second SMS message including an identification of the coin object having the at least the minimum value, a versioned ID of object, and a digest.

According to some examples, the method includes receiving data input into a user interface of the application that is effective to define at least a recipient wallet address and a type of transaction to occur on the blockchain at block 206. For example, the mobile application 102 illustrated in FIG. 1 may receive data input into a user interface of the application that is effective to define at least a recipient wallet address and a type of transaction to occur on the blockchain.

According to some examples, the method includes sending a third SMS message including a signature for the sender, and transaction details including at least the wallet address of the sender, an identification of the coin object as a gas input, the recipient wallet address, and the type of transaction at block 208.

In addition to the previously addressed embodiments, the mobile application 102 can be implemented using either a blockchain SDK native to the mobile device operating system or a Java version of the blockchain SDK integrated within mobile application 102.

In some examples, in order to further enhance an seamless and holistic internet-less experience with Sui through SMS, additional features can be integrated to interact with the mobile application 102. In some examples, JavaScript-based mobile frameworks could make use of the existing and well-supported Typescript Sui SDK[1], while being integrated with a device OS with low-level features related to submitting and listening to SMS.

In some embodiments, the content of SMS messages is adjusted to account for message size, with data compression being a key consideration. Although using Base64 encoding is straightforward, the use of Base64 can result in multi-segmented SMS messages, each wrapping from 4 to 10 individual SMS segments. This can lead to significant costs for users when submitting these messages.

Shortening messages includes the use of one or more compression algorithms on the original data transferred via SMS before converting it to Base64 format. Another approach involves configuring the blockchain proxy that receives the original SMS content via HTTP to handle more responsibilities.

For example, the proxy can be designed to function as an indexer that stores user-associated information, such as addresses. This eliminates the need to include the entire address in the SMS sent by the app, requiring a part of it to avoid collisions. Similarly, a set of transaction mappings can be defined within the trusted service. This allows the mobile application to send the mapping key for the desired transaction instead of the original transaction bytes over SMS. For instance, ‘1’ could represent transferring SUI, and ‘2’ could represent minting a specific type of NFT.

In a more custodial approach, the submission of the user's signature via SMS can be avoided by storing the information on the trusted service side, enabling it to create the signature for the requested transaction on behalf of the user 104.

In an alternative example, aiming for a decentralized flow, the blockchain proxy that the SMS forwarding service calls via HTTP is injected directly within the full nodes of the blockchain or into a native blockchain infrastructure component. This approach enhances the solution's alignment with the decentralized nature of blockchains, eliminating the need for trusted services. Taking this idea further, indexers can be spun off to “cache” specific data for users, offering it in a templated manner.

In some embodiments, additional receiving functionality is integrated into the mobile application 102. When there is an on-chain asset transmission, such as transferring crypto coins, NFTs, or other assets, the receiver is informed about the associated transaction via an incoming SMS. A push notification triggered by the app on their phone provides all the transaction details, which are presented in an encoded format within the incoming SMS. The mobile application 102 decodes the incoming SMS, prepares the push notification, and renders the associated information within the application. Furthermore, the mobile application 102 is enhanced with verification capabilities, allowing the incoming SMS to be verified, for example, by being signed with a validator's signature.

As addressed above, other communication channels are possible. For example, devices can submit and receive data directly to/from satellites or other technologies. This may cause the mobile device to connect to other devices via Bluetooth or other local communication techniques in order to take advantage of hardware or services that are not present on the mobile device.

The mobile application 102 is enhanced to receive and submit messages from devices connected to the mobile phone via Bluetooth. In this setup, the mobile application 102 can prepare encoded transaction data using a Sui SDK, and the encoded data to a mobile device via Bluetooth, where the mobile device submits it either through the satellite network or through AM broadcasting.

The mobile application 102 can also be extended to provide messaging capabilities through a long range network (LoRa). Data is transmitted through a network of LoRa-compatible antennas in areas with coverage. The mobile application 102 also supports data transmission within a Decentralized Physical Infrastructure (DePIN) cluster, which opens up new opportunities for developing decentralized applications.

In some examples, where an internet-less approach is not imminent, executing transactions using tweets or other Fediverse social media platforms like Mastodon can follow a similar mechanic to the SMS approach. For example, a custom mobile application 102 can integrate with the social media's SDK to post tweets, while a backend service monitors these tweets and executes the associated transactions through the Sui SDK.

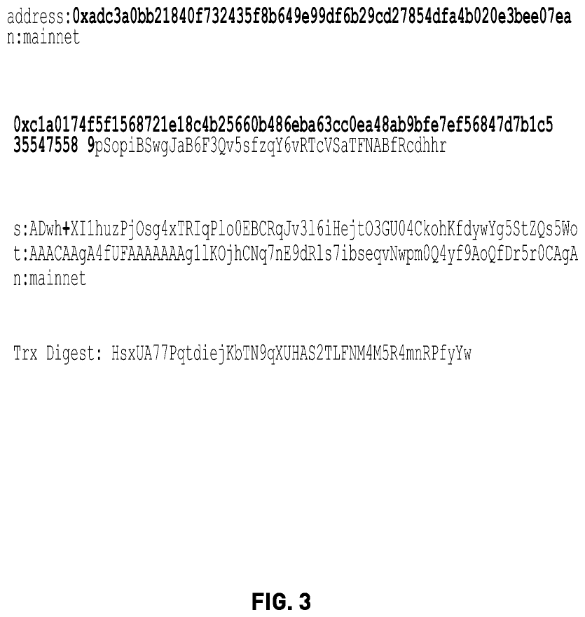

FIG. 3 illustrates the contents of SMS messages exchanged in accordance with some aspects of the present technology.

When a user interacts with mobile application 102, as depicted in FIG. 1, to transact with a blockchain using non-internet protocol messages like SMS, the user can first enter a mnemonic passphrase to import one or more wallet keys associated with the mobile application 102, which will be used as the sender for the transaction. The mobile application 102 then prompts the user to select the network for the blockchain transaction, allows the user to input the recipient's address, and provides an execution button to complete the transaction. Execution of the transaction by the user can cause one or more messages to be transmitted and/or received by the user device.

Upon execution, mobile application 102 prepares and submits an SMS containing the sender address and the targeted network, encoded in Base64 format, as illustrated in the first SMS message 302. The targeted network may be specified as either mainnet, testnet, or both.

The first SMS message 302 triggers an HTTP call to the trusted service, where the service selects the first non-zero balance owned by the address. Specific fields of the address are then converted to Base64 format and sent back as a response via SMS to the user's number. The second SMS message 304, as depicted in FIG. 3, includes an identification of the coin object on the targeted network (mainnet, testnet, etc.), encoded in Base64 format.

The mobile application 102 listens for incoming SMS messages, and upon receiving the second SMS message 304, mobile application 102 decodes the fields within the message. Using the Sui Java community blockchain SDK, the application creates an object from this data. The mobile application 102 then uses this object, along with other relevant fields, to prepare the transaction block data and the signature for the transaction. Once these elements are ready, the application converts both the signature and transaction data to Base64 format. Mobile application 102 then composes and submits an SMS containing the blockchain transaction data, including the received coin object information and the user signature, as the third SMS message 306 to a trusted service as the recipient.

The trusted service recipient receives the third SMS message 306 and decodes its fields. Using the Sui TS SDK, the recipient executes the transaction with the transaction bytes and signature received via SMS. After executing the transaction, the recipient sends the transaction digest back to the user via SMS as the fourth SMS message 308, for confirmation.

The mobile application 102 listens for this SMS and displays its content on the app's screen. The fourth SMS message 308 contains the transaction digest encoded in Base64 format.

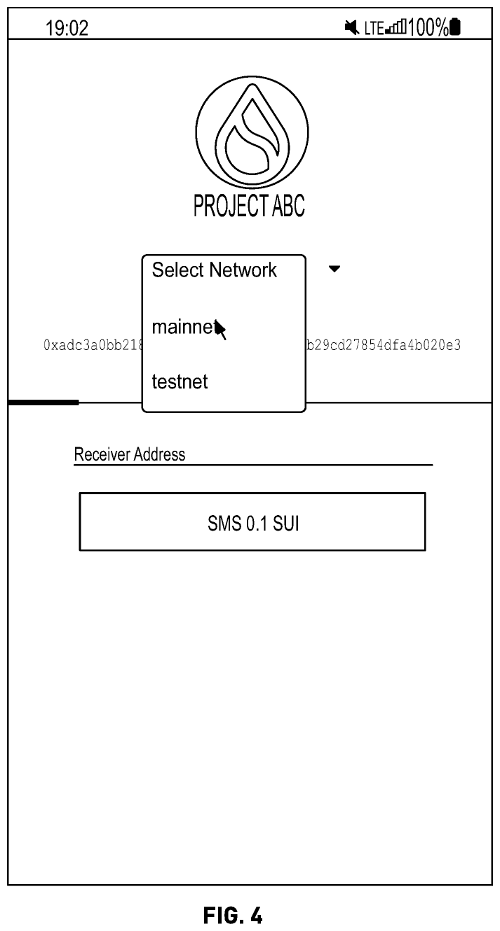

FIG. 4 illustrates an example user interface 400 of the mobile application used to configure a request for a token with a non-zero value in accordance with some aspects of the present technology.

The user accesses the main mobile application screen 402, which serves as the central interface for initiating transactions. From this screen, the user is prompted to enter relevant details for the transaction, including a location where the transaction will occur. The application further prompts the user to select the network for the transaction via network selection 404. If the user does not make a selection, the application defaults to “TestNet.” Additionally, the main mobile application screen 402 includes a prompt for the user to provide a receiver address via receiver address selection 406. Once all inputs are provided, the user can press the execution button 408 to initiate the transaction.

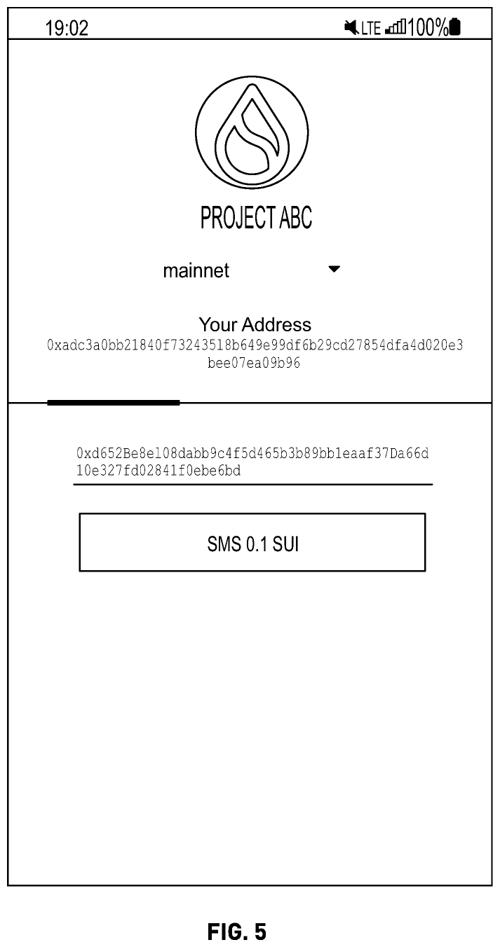

FIG. 5 illustrates an example user interface of the mobile application after submitting an SMS to a recipient, where the user interface identifies the token with the non-zero value in accordance with some aspects of the present technology.

In furtherance of the method illustrated in FIG. 4, and as depicted in FIG. 5, the user selects “mainnet” for the network in network selection 404 and specifies a recipient address in receiver address selection 406. Upon interaction with the execution button 408, the mobile application 102, as shown in FIG. 1, triggers the execution of the blockchain transaction. This action prompts the mobile application 102 to prepare and submit an SMS to the recipient address indicated in recipient selection 406. The SMS includes the sender's address—the user initiating the transaction—and the chosen network, “mainnet,” as selected in network selection 404.

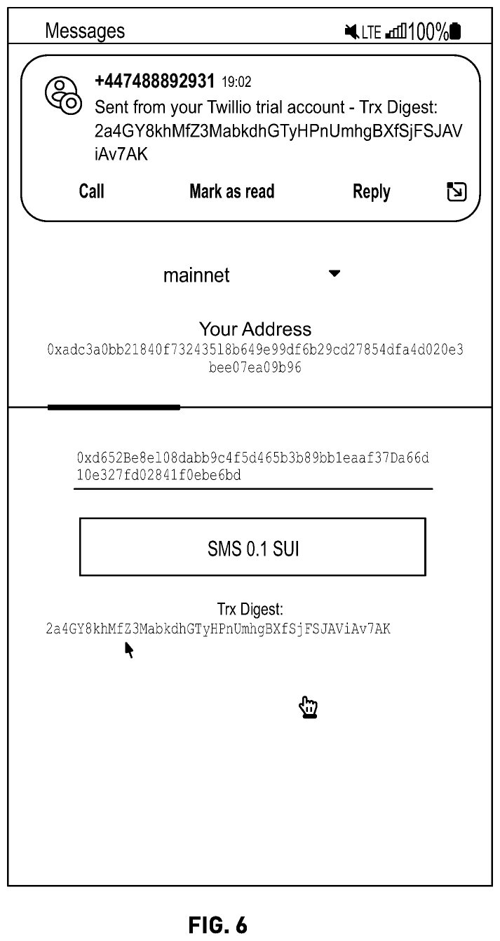

FIG. 6 illustrates an example user interface of the mobile application as it receives the fourth SMS message including a transaction digest showing that the transaction on the blockchain was completed in accordance with some aspects of the present technology.

As detailed with reference to FIG. 3, once the user selects the execution button 408, the recipient receives the request sent by the mobile application 102. This results in the transmission of the second SMS message 304 from the recipient, which identifies an object associated with the address. Following this, the mobile application 102 responds by sending the third SMS message 306 to the recipient, as outlined in FIG. 3. The recipient then receives this SMS, decodes its fields, and utilizes the Sui TS SDK to execute the transaction using the transaction bytes and signature provided via SMS.

Upon completing the transaction execution, the recipient sends the transaction digest back to the user via SMS. The mobile application 102 receives this SMS and renders the transaction digest in a notification 602, displaying the content on the main mobile application screen 402. This ensures the user is promptly informed of the transaction outcome through a clear and immediate update on the application interface.

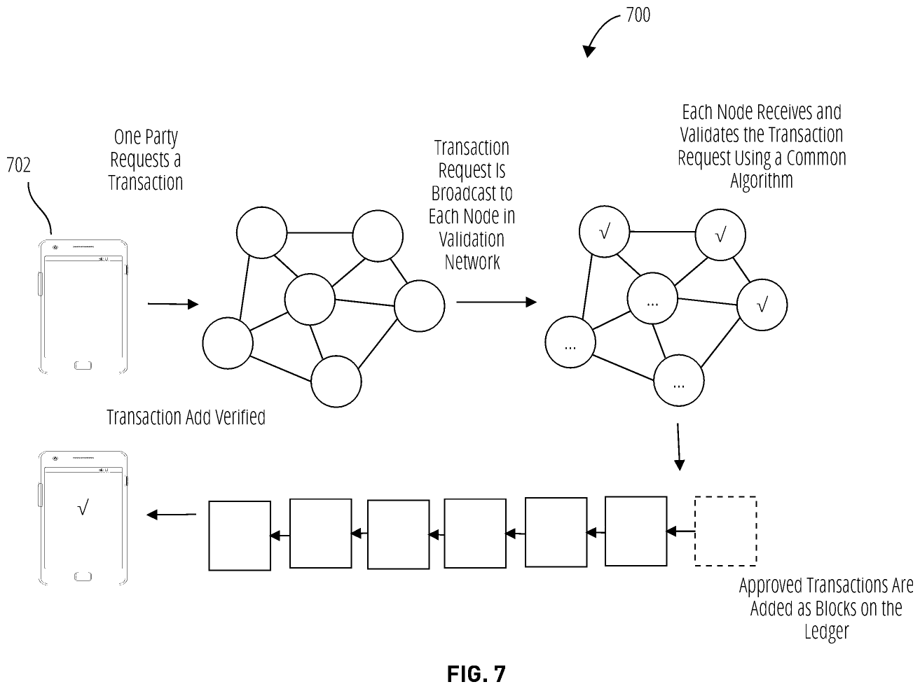

Referring to FIG. 7, a blockchain is an ever-growing set of data blocks. Each block records a collection of transactions. Blockchains distribute these transactions across a group of computers. Each computer maintains its own copy of the blockchain transactions.

A blockchain is a continuously growing list of records, called blocks, which are linked and secured using cryptography. Each block typically comprises a cryptographic hash of the previous block, a timestamp, and transaction data. By design, a blockchain is resistant to modification of the data. Blockchains may implement an open, distributed ledger that can record transactions between two parties efficiently and in a verifiable and permanent way.

A blockchain is typically managed by multiple parties collectively adhering to a protocol for inter-node communication and validating new blocks. Once recorded, the data in any given block cannot be altered retroactively without alteration of all subsequent blocks, which elicits consensus among the operators.

Cryptography involving mathematical methods of keeping data secret and proving identity is utilized when recording transactions. One digital key ensures an owner can enter a transaction to the blockchain involving their assets, and another digital key lets other parties confirm it really was the owner who added the transaction.

Blockchain is resistant to tampering or other changes by utilizing a cryptographic technique called the hash. Hashing reduces data to a sequence of seemingly random characters—for example, the hash of the phrase “the quick brown fox” is “9ECB36561341D18EB65484E833EFEA61EDC74B84CF5E6AE1B81C63533E25FC8F” using a hash method called SHA-256. Tweaking just one letter in the phrase produces a completely different hash, and you can't go backward to figure out the original data from the hash.

With blockchain, hashes are linked together, so any last-minute change is immediately visible, not just for the block housing it but for all other blocks added later. With red flags that big for changes that small, auditing becomes easier.

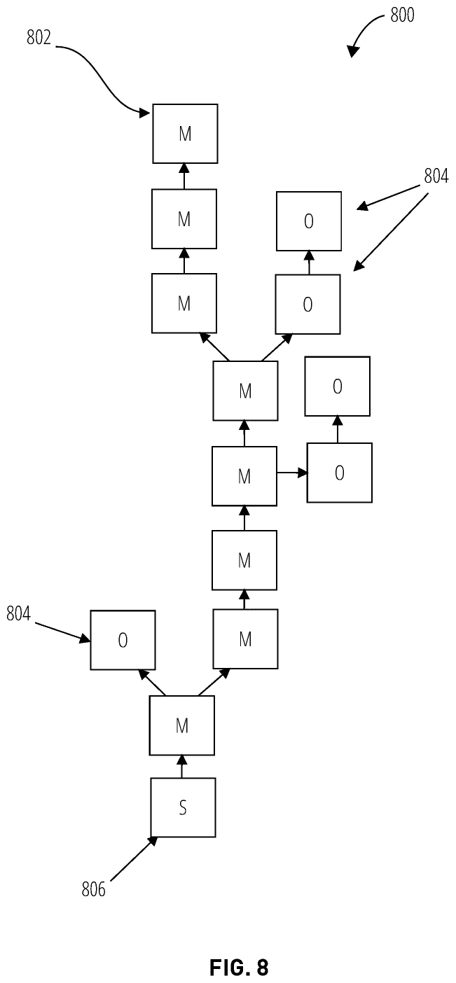

FIG. 8 illustrates an exemplary blockchain formation 800. The mainchain 802 (M blocks) comprises the longest series of blocks from the start block 806 (S block) to the current block. Orphan blocks 804 (O blocks) exist outside of the main chain.

Blocks hold batches of valid transactions that are hashed and encoded, for example into a Merkle tree. Each block includes the cryptographic hash of the prior block in the blockchain formation 800, linking the two. The linked blocks form a chain. This iterative process confirms the integrity of the previous block, all the way back to the original start block 806.

Sometimes separate blocks can be produced concurrently, creating a temporary fork. In addition to a secure hash-based history, the blockchain formation 800 has a specified algorithm for scoring different versions of the history so that one with a higher value can be selected over others. Blocks not selected for inclusion in the mainchain 802 are called orphan blocks 804. Peers supporting the blockchain formation 800 have different versions of the history from time to time. They keep only the highest-scoring version of the blockchain formation 800 known to them. Whenever a peer receives a higher-scoring version (usually the old version with a single new block added) they extend or overwrite their local version of the blockchain formation 800 and retransmit the improvement to their peers. There is never an absolute guarantee that any particular entry will remain in the best version of the history forever. Because blockchains are typically built to add the score of new blocks onto old blocks and because there are incentives to work only on extending with new blocks rather than overwriting old blocks, the probability of an entry becoming superseded goes down exponentially as more blocks are built on top of it, eventually becoming very low. For example, in a blockchain using the proof-of-work system, the chain with the most cumulative proof-of-work is always considered the valid one by the network. There are a number of methods that can be used to demonstrate a sufficient level of computation. Within a blockchain the computation is carried out redundantly rather than in the traditional segregated and parallel manner.

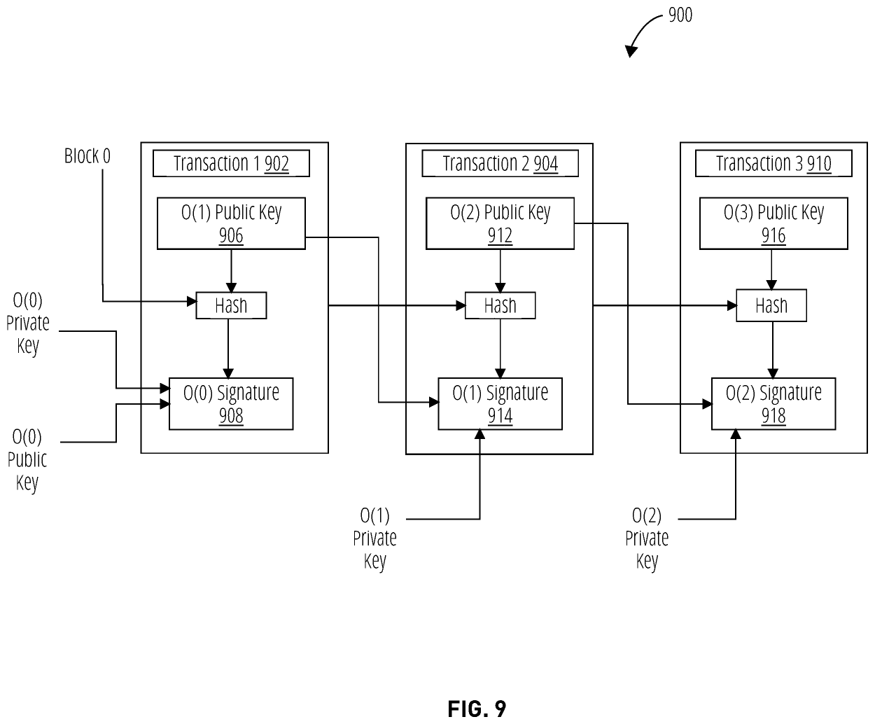

FIG. 9 illustrates an embodiment of an irreversible transaction blockchain 900. The blockchain 900 is a sequence of digitally signed transactions (transaction 1 902, transaction 2 904, and transaction 3 910 etc.). Each transaction includes the current owners public key (block 1 owner public key 906, block 2 owner public key 912, and block 3 owner public key 916 respectively) and the previous owner's signature (O(0) signature 908, O(1) signature 914, and O(2) signature 918) which are generated using a hash function. The owner of a transaction can examine each previous transaction to verify the chain of ownership. Unlike traditional check endorsements, the transactions in the blockchain 900 are irreversible, which mitigates fraud.

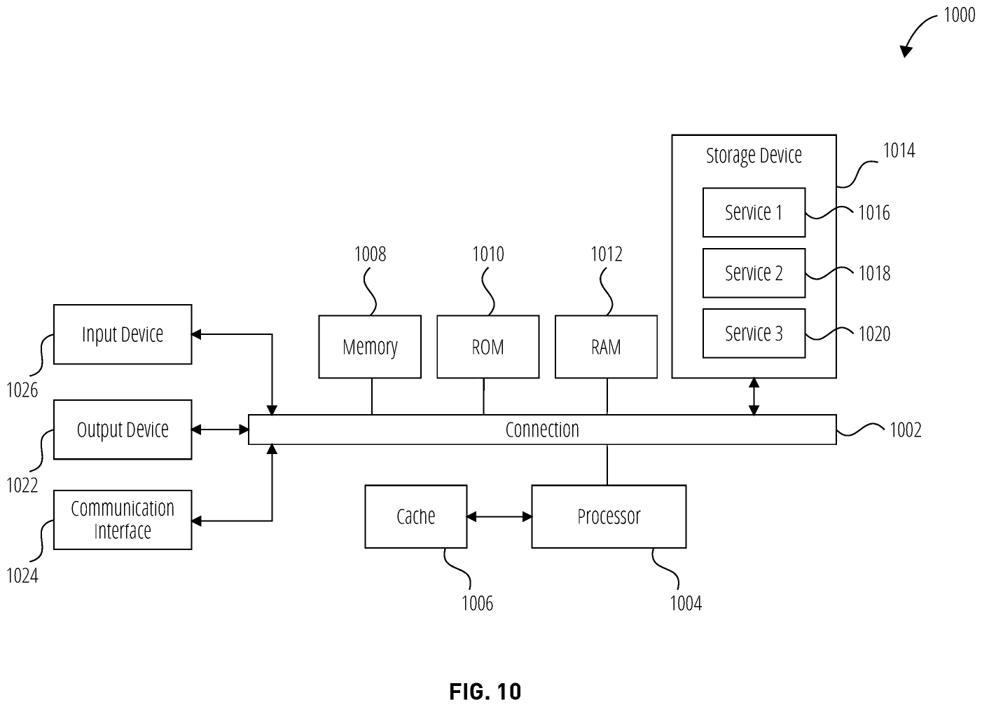

FIG. 10 shows an example of computing system 1000, which can be for example any computing device, or any component thereof in which the components of the system are in communication with each other using connection 1002. Connection 1002 can be a physical connection via a bus, or a direct connection into processor 1004, such as in a chipset architecture. Connection 1002 can also be a virtual connection, networked connection, or logical connection.

In some embodiments, computing system 1000 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 1000 includes at least one processing unit (CPU or processor) 1004 and connection 1002 that couples various system components including system memory 1008, such as read-only memory (ROM) 1010 and random access memory (RAM) 1012 to processor 1004. Computing system 1000 can include a cache of high-speed memory 1006 connected directly with, in close proximity to, or integrated as part of processor 1004.

Processor 1004 can include any general purpose processor and a hardware service or software service, such as services 1016, 1018, and 1020 stored in storage device 1014, configured to control processor 1004 as well as a special-purpose processor where software instructions are incorporated into the actual processor design. Processor 1004 may essentially be a completely self-contained computing system, containing multiple cores or processors, a bus, memory controller, cache, etc. A multi-core processor may be symmetric or asymmetric.

To enable user interaction, computing system 1000 includes an input device 1026, which can represent any number of input mechanisms, such as a microphone for speech, a touch-sensitive screen for gesture or graphical input, keyboard, mouse, motion input, speech, etc. Computing system 1000 can also include output device 1022, which can be one or more of a number of output mechanisms known to those of skill in the art. In some instances, multimodal systems can enable a user to provide multiple types of input/output to communicate with computing system 1000. Computing system 1000 can include communication interface 1024, which can generally govern and manage the user input and system output. There is no restriction on operating on any particular hardware arrangement, and therefore the basic features here may easily be substituted for improved hardware or firmware arrangements as they are developed.

Storage device 1014 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 1014 can include software services, servers, services, etc., that when the code that defines such software is executed by the processor 1004, it causes the system to perform a function. In some embodiments, a hardware service that performs a particular function can include the software component stored in a computer-readable medium in connection with the hardware components, such as processor 1004, connection 1002, output device 1022, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per sc.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Some aspects of the present technology include:
Clause 1. A method comprising: sending, by an application, a first short message service (SMS) message, the first SMS message requesting a coin object having at least a minimum value and identifying a wallet address of a sender, the coin object being stored on a blockchain; receiving, by the application, a second SMS message, the second SMS message including an identification of the coin object having the at least the minimum value, a versioned ID of object, and a digest; receiving, by the application, data input into a user interface of the application that is effective to define at least a recipient wallet address and a type of transaction to occur on the blockchain; sending, by the application, a third SMS message, the third SMS message including a signature for the sender, and transaction details including at least the wallet address of the sender, an identification of the coin object as a gas input, the recipient wallet address, and the type of transaction; and receiving, by the application, a fourth SMS message, the fourth SMS message including a transaction digest with proof that the transaction has been recorded on the blockchain.
Clause 2. The method of clause 1, wherein content within the SMS messages are exchanged between a blockchain proxy and the application, wherein the blockchain proxy is configured to translate a context with the SMS messages into messages compatible with a blockchain software developer kit.
Clause 3. The method of clause 2, wherein the SMS messages are exchanged with an SMS forwarding service, wherein the SMS forwarding service is configured to be an interface between an SMS network and an IP network, wherein the SMS forwarding service communicates with the application over the SMS network and communicates with the blockchain proxy over an IP network, wherein the SMS forwarding service forwards messages received from the application to the blockchain proxy and forwards messages received from the blockchain proxy to the application.
Clause 4. The method of clause 3, wherein the SMS forwarding service is co-located with a blockchain node.
Clause 5. The method of clause 3, wherein the SMS forwarding service is co-located with the blockchain proxy.
Clause 6. The method of clause 1, wherein any of the first SMS message, the second SMS message, the third SMS message, or the fourth SMS message are divided over a plurality of SMS transmissions in order to keep the SMS transmissions under a maximum character length.
Clause 7. The method of clause 1, wherein the any of the first SMS message, the second SMS message, the third SMS message, or the fourth SMS message are encoded to a number of characters less than a maximum character length for an SMS transmission, wherein the application and a blockchain proxy are endowed with instructions to decode the SMS transmission.
Clause 8. The method of clause 1, wherein the application can select from one of several blockchain networks o which to conduct the transaction, and the first SMS message and the second SMS message identify the one of the several blockchain networks.
Clause 9. The method of clause 1, wherein the SMS message could be substituted for FM/AM radio signals, or satellite transmissions.
Clause 10. A system comprising: one or more processors; and memory storing thereon instructions that, as a result of being executed by the one or more processors, cause the system to: send, by an application, a first short message service (SMS) message, the first SMS message requesting a coin object having at least a minimum value and identifying a wallet address of a sender, the coin object being stored on a blockchain; receive, by the application, a second SMS message, the second SMS message including an identification of the coin object having the at least the minimum value, a versioned ID of object, and a digest; receive, by the application, data input into a user interface of the application that is effective to define at least a recipient wallet address and a type of transaction to occur on the blockchain; send, by the application, a third SMS message, the third SMS message including a signature for the sender, and transaction details including at least the wallet address of the sender, an identification of the coin object as a gas input, the recipient wallet address, and the type of transaction; and receive, by the application, a fourth SMS message, the fourth SMS message including a transaction digest with proof that the transaction has been recorded on the blockchain.
Clause 11. The system of clause 10, wherein content within the SMS messages are exchanged between a blockchain proxy and the application, wherein the blockchain proxy is configured to translate a context with the SMS messages into messages compatible with a blockchain software developer kit.
Clause 12. The system of clause 10, wherein: the SMS messages are exchanged with an SMS forwarding service, wherein the SMS forwarding service is configured to be an interface between an SMS network and an IP network, the SMS forwarding service communicates with the application over the SMS network and communicates with a blockchain proxy over an IP network, and the SMS forwarding service forwards messages received from the application to the blockchain proxy and forwards messages received from the blockchain proxy to the application.
Clause 13. The system of clause 12, wherein the SMS forwarding service is co-located with a blockchain node.
Clause 14. The system of clause 12, wherein the SMS forwarding service is co-located with the blockchain proxy.
Clause 15. The system of clause 10, wherein any of the first SMS message, the second SMS message, the third SMS message, or the fourth SMS message are divided over a plurality of SMS transmissions in order to keep the SMS transmissions under a maximum character length.
Clause 16. The system of clause 10, wherein the any of the first SMS message, the second SMS message, the third SMS message, or the fourth SMS message are encoded to a number of characters less than a maximum character length for an SMS transmission, wherein the application and a blockchain proxy are endowed with instructions to decode the SMS transmission.
Clause 17. The system of clause 10, wherein the application can select from one of several blockchain networks on which to conduct the transaction, and the first SMS message and the second SMS message identify the one of the several blockchain networks.
Clause 18. A non-transitory computer-readable storage medium, the computer-readable storage medium including instructions that when executed by a computer, cause the computer to: send, by an application, a first short message service (SMS) message, the first SMS message requesting a coin object having at least a minimum value and identifying a wallet address of a sender, the coin object being stored on a blockchain; receive, by the application, a second SMS message, the second SMS message including an identification of the coin object having the at least the minimum value, a versioned ID of object, and a digest; receive, by the application, data input into a user interface of the application that is effective to define at least a recipient wallet address and a type of transaction to occur on the blockchain; send, by the application, a third SMS message, the third SMS message including a signature for the sender, and transaction details including at least the wallet address of the sender, an identification of the coin object as a gas input, the recipient wallet address, and the type of transaction; and receive, by the application, a fourth SMS message, the fourth SMS message including a transaction digest with proof that the transaction has been recorded on the blockchain.
Clause 19. The non-transitory computer-readable storage medium of clause 18, wherein content within the SMS messages are exchanged between a blockchain proxy and the application, wherein the blockchain proxy is configured to translate a context with the SMS messages into messages compatible with a blockchain software developer kit.
Clause 20. The non-transitory computer-readable storage medium of clause 19, wherein the SMS messages are exchanged with an SMS forwarding service, wherein the SMS forwarding service is configured to be an interface between an SMS network and an IP network, wherein the SMS forwarding service communicates with the application over the SMS network and communicates with the blockchain proxy over an IP network, wherein the SMS forwarding service forwards messages received from the application to the blockchain proxy and forwards messages received from the blockchain proxy to the application.
Clause 21. The non-transitory computer-readable storage medium of clause 20, wherein the SMS forwarding service is co-located with a blockchain node.
Clause 22. The non-transitory computer-readable storage medium of clause 20, wherein the SMS forwarding service is co-located with the blockchain proxy.
Clause 23. The computer-readable storage medium of clause 18, wherein any of the first SMS message, the second SMS message, the third SMS message, or the fourth SMS message are divided over a plurality of SMS transmissions in order to keep the SMS transmissions under a maximum character length.
Clause 24. The non-transitory computer-readable storage medium of clause 18, wherein the any of the first SMS message, the second SMS message, the third SMS message, or the fourth SMS message are encoded to a number of characters less than a maximum character length for an SMS transmission, wherein the application and a blockchain proxy are endowed with instructions to decode the SMS transmission.
Clause 25. The non-transitory computer-readable storage medium of clause 18, wherein the application can select from one of several blockchain networks o which to conduct the transaction, and the first SMS message and the second SMS message identify the one of the several blockchain networks.
Clause 26. The non-transitory computer-readable storage medium of clause 18, wherein the SMS message could be substituted for FM/AM radio signals or satellite transmissions.

What is claimed is:

1. A method comprising:
sending, by an application, a first short message service (SMS) message, the first SMS message requesting a coin object having at least a minimum value and identifying a wallet address of a sender, the coin object being stored on a blockchain;
receiving, by the application, a second SMS message, the second SMS message including an identification of the coin object having the at least the minimum value, a versioned ID of object, and a digest;
receiving, by the application, data input into a user interface of the application that is effective to define at least a recipient wallet address and a type of transaction to occur on the blockchain;
sending, by the application, a third SMS message, the third SMS message including a signature for the sender, and transaction details including at least the wallet address of the sender, an identification of the coin object as a gas input, the recipient wallet address, and the type of transaction; and
receiving, by the application, a fourth SMS message, the fourth SMS message including a transaction digest with proof that the transaction has been recorded on the blockchain.

2. The method of claim 1, wherein content within the SMS messages are exchanged between a blockchain proxy and the application, wherein the blockchain proxy is configured to translate a context with the SMS messages into messages compatible with a blockchain software developer kit.

3. The method of claim 2, wherein the SMS messages are exchanged with an SMS forwarding service, wherein the SMS forwarding service is configured to be an interface between an SMS network and an IP network, wherein the SMS forwarding service communicates with the application over the SMS network and communicates with the blockchain proxy over an IP network, wherein the SMS forwarding service forwards messages received from the application to the blockchain proxy and forwards messages received from the blockchain proxy to the application.

4. The method of claim 1, wherein any of the first SMS message, the second SMS message, the third SMS message, or the fourth SMS message are divided over a plurality of SMS transmissions in order to keep the SMS transmissions under a maximum character length.

5. The method of claim 1, wherein the any of the first SMS message, the second SMS message, the third SMS message, or the fourth SMS message are encoded to a number of characters less than a maximum character length for an SMS transmission, wherein the application and a blockchain proxy are endowed with instructions to decode the SMS transmission.

6. The method of claim 1, wherein the application can select from one of several blockchain networks to which to conduct the transaction, and the first SMS message and the second SMS message identify the one of the several blockchain networks.

7. The method of claim 1, wherein the SMS message could be substituted for FM/AM radio signals, or satellite transmissions.

8. A system comprising:
one or more processors; and
memory storing thereon instructions that, as a result of being executed by the one or more processors, cause the system to:
send, by an application, a first short message service (SMS) message, the first SMS message requesting a coin object having at least a minimum value and identifying a wallet address of a sender, the coin object being stored on a blockchain;
receive, by the application, a second SMS message, the second SMS message including an identification of the coin object having the at least the minimum value, a versioned ID of object, and a digest;
receive, by the application, data input into a user interface of the application that is effective to define at least a recipient wallet address and a type of transaction to occur on the blockchain;
send, by the application, a third SMS message, the third SMS message including a signature for the sender, and transaction details including at least the wallet address of the sender, an identification of the coin object as a gas input, the recipient wallet address, and the type of transaction; and
receive, by the application, a fourth SMS message, the fourth SMS message including a transaction digest with proof that the transaction has been recorded on the blockchain.

9. The system of claim 8, wherein content within the SMS messages are exchanged between a blockchain proxy and the application, wherein the blockchain proxy is configured to translate a context with the SMS messages into messages compatible with a blockchain software developer kit.

10. The system of claim 8, wherein:
the SMS messages are exchanged with an SMS forwarding service, wherein the SMS forwarding service is configured to be an interface between an SMS network and an IP network,
the SMS forwarding service communicates with the application over the SMS network and communicates with a blockchain proxy over an IP network, and
the SMS forwarding service forwards messages received from the application to the blockchain proxy and forwards messages received from the blockchain proxy to the application.

11. The system of claim 8, wherein any of the first SMS message, the second SMS message, the third SMS message, or the fourth SMS message are divided over a plurality of SMS transmissions in order to keep the SMS transmissions under a maximum character length.

12. The system of claim 8, wherein the any of the first SMS message, the second SMS message, the third SMS message, or the fourth SMS message are encoded to a number of characters less than a maximum character length for an SMS transmission, wherein the application and a blockchain proxy are endowed with instructions to decode the SMS transmission.

13. The system of claim 8, wherein the application can select from one of several blockchain networks on which to conduct the transaction, and the first SMS message and the second SMS message identify the one of the several blockchain networks.

14. A non-transitory computer-readable storage medium, the computer-readable storage medium including instructions that when executed by a computer, cause the computer to:
send, by an application, a first short message service (SMS) message, the first SMS message requesting a coin object having at least a minimum value and identifying a wallet address of a sender, the coin object being stored on a blockchain;
receive, by the application, a second SMS message, the second SMS message including an identification of the coin object having the at least the minimum value, a versioned ID of object, and a digest;
receive, by the application, data input into a user interface of the application that is effective to define at least a recipient wallet address and a type of transaction to occur on the blockchain;
send, by the application, a third SMS message, the third SMS message including a signature for the sender, and transaction details including at least the wallet address of the sender, an identification of the coin object as a gas input, the recipient wallet address, and the type of transaction; and
receive, by the application, a fourth SMS message, the fourth SMS message including a transaction digest with proof that the transaction has been recorded on the blockchain.

15. The non-transitory computer-readable storage medium of claim 14, wherein content within the SMS messages are exchanged between a blockchain proxy and the application, wherein the blockchain proxy is configured to translate a context with the SMS messages into messages compatible with a blockchain software developer kit.

16. The non-transitory computer-readable storage medium of claim 15, wherein the SMS messages are exchanged with an SMS forwarding service, wherein the SMS forwarding service is configured to be an interface between an SMS network and an IP network, wherein the SMS forwarding service communicates with the application over the SMS network and communicates with the blockchain proxy over an IP network, wherein the SMS forwarding service forwards messages received from the application to the blockchain proxy and forwards messages received from the blockchain proxy to the application.

17. The computer-readable storage medium of claim 14, wherein any of the first SMS message, the second SMS message, the third SMS message, or the fourth SMS message are divided over a plurality of SMS transmissions in order to keep the SMS transmissions under a maximum character length.

18. The non-transitory computer-readable storage medium of claim 14, wherein the any of the first SMS message, the second SMS message, the third SMS message, or the fourth SMS message are encoded to a number of characters less than a maximum character length for an SMS transmission, wherein the application and a blockchain proxy are endowed with instructions to decode the SMS transmission.

19. The non-transitory computer-readable storage medium of claim 14, wherein the application can select from one of several blockchain networks o which to conduct the transaction, and the first SMS message and the second SMS message identify the one of the several blockchain networks.

20. The non-transitory computer-readable storage medium of claim 14, wherein the SMS message could be substituted for FM/AM radio signals or satellite transmissions.
